(19) United States
(12) Patent Application Publication
(10) Pub. No.: US 2002/0131068 A1
(43) Pub. Date: Sep. 19, 2002

(54) Image recording apparatus and image recording method

(76) Inventors: Yoshio Ishii, Kanagawa (JP); Eiichi Kito, Kanagawa (JP); Atsushi Uejima, Kanagawa (JP); Osamu Takahashi, Kanagawa (JP)

Correspondence Address: Young & Thompson, Suite 200, 745 South 23rd Street, Arlington, VA, 22202, US

(21) Appl. No.: 09/994,712

(22) Filed: Nov. 28, 2001

(30) Foreign Application Priority Data
Nov. 28, 2000 (JP) 2000-361518

(51) Int. Cl. G06K 15/02; G06K 15/10; G06F 15/00; B41J 2/165; B41J 2/175

(52) U.S. Cl. 358/1.14; 382/112; 347/23; 358/1.16; 347/85

(57) ABSTRACT

The invention achieves high image recording ability with an ink jet recording method and an improvement in acquisition rate of proper images. On the basis of inputted image data for recording, an ejection signal for driving a recording head which records an image with an ink jet method is generated. Then, the head is driven and images are recorded successively on the recording material. Simultaneously, images thus outputted are read by a sensor. By comparing the output image data obtained by the reading to the corresponding image data for recording, or comparing output image data of output images with one another, whether phenomena including clogging of an ejection opening of the recording and a decrease in an ejection amount of ink droplets and the like have occurred is monitored. If any of the phenomena has occurred, a process for solving the phenomenon is performed.

### BACKGROUND OF THE INVENTION

1. Field of the Invention

The present invention relates to an image recording apparatus and an image recording method. In particular, the present invention relates to an image recording apparatus which records an image by adhering recording droplets that were ejected from ejection openings of a recording head to a recording medium based on image information, and an image recording method which can be applied to the image recording apparatus.

2. Description of the Related Art

The most general method for filming a subject which is filmed and then recording a color image of the subject onto a recording medium such as a recording paper or the like is a method which uses a silver halide color photosensitive material. In this method, a silver halide color photographic photosensitive material for filming such as a negative film or the like is loaded into a camera. Then, the subject is shot by the camera such that an image of the subject is exposed and recorded on the photographic photosensitive material for shooting (a latent image is formed). A latent image formed on the photographic photosensitive material for shooting becomes visible as an image by a development process comprising the process of color development, bleaching/fixing, washing and drying is performed on the photographic photosensitive material for shooting after the filming has been completed.

Then, light is irradiated onto the image formed on the photographic photosensitive material for filming. The light which has been transmitted through or reflected by the image is directly irradiated onto a silver halide color photographic photosensitive material for appreciation such as a color paper (photographic printing paper). Alternatively, the image formed on the photographic photosensitive material for shooting is optically read, light is modulated in accordance with image information obtained by the reading of the image, and then irradiated onto the photographic photosensitive material for appreciation. Thus, the image is exposed and recorded on the photographic photosensitive material for appreciation (a latent image formation). Then, the photographic photosensitive material for appreciation with an image exposed and recorded thereon is subjected to development processing including color formation development, bleaching/fixing, washing and drying. In this way, a latent image formed on the photographic photosensitive material for appreciation becomes visible, and a color image of the subject (photographic print) can be obtained.

However, in the development process, a photographic photosensitive material must be immersed successively in multiple kinds of processing solutions. In addition, types of processing solutions required for photographic photosensitive material for shooting are different from those of photographic photosensitive material for appreciation. Moreover, in image recording methods utilizing a silver halide color photosensitive material, because dyes are formed by chemical reactions in the processing solutions, an image quality of an output image is easily affected by temperatures or components of the processing solutions, which must therefore be maintained at a constant temperature. Further, replenishment solutions must be appropriately replenished depending on a degree of deterioration of the processing solutions. Thus, for image recording methods which utilize the silver halide color photosensitive material, there are problems that a device is large and complicated and maintenance thereof bothers an operator. Although various improvements have been conventionally carried out in order to accomplish a device which is compact and does not require maintenance, a device which is even more compact and does not require maintenance is still desired.

Further, in the image recording method which utilizes a silver halide color photosensitive material, it is problematic that variations in exposure or development processes with respect to the photographic photosensitive material for appreciation, or of characteristics of the photographic photosensitive material for appreciation itself may affect directly an image quality of an output color image. Japanese Patent Application Laid-Open No. 2000-33732 proposes a technique that absorbs variations of characteristics of a recording material or of exposure or the like by correcting an exposure amount based on data expressing a relationship between an exposure amount of the recording material and a color formation density of the recording material or on a density of a test chart image. However, further stabilization of the image quality is needed.

An ink jet recording method in which an ink droplet ejected from an ejection opening of a recording head is adhered to a recording medium such that an image is recorded on the recording medium is known as another image recording method widely used for applications including recording of data outputted from a computer onto a recording medium as an image. The ink jet recording method has an advantage that variation of image density due to variation of environmental conditions such as temperature and the like is small because an image is recorded by adhering directly a dye solution (ink) to the recording medium. Compared to the image recording method which utilizes a silver halide color photosensitive material, the ink jet recording method is basically advantageous in view of its maintainability.

However, the ink jet recording method has a problem that abnormalities such as failure to eject ink droplets and the like caused by clogging of ejection openings of the recording head may occur, causing easily visible fatal flows such as generating white lines in the images.

Such problem becomes a significant drawback particularly in a case of successively recording a large number of images onto a recording medium. For example, when 24, 36 or 40 frame images recorded in one photographic film have been successively recorded and then the above-described defective portions are found, all images must be recorded again. Thus, such problem leads to significant decreases in processing ability (number of recorded images per unit time) and in an acquisition rate of output images with an appropriate image quality.

HYPERPHOTO SYSTEM 100 manufactured by Canon Inc. is known as an image recording system in which images recorded in a color negative film subjected to development process are read, and the images are recorded on a recording medium with an ink jet recording method. A printer H-100 included in the system has a function of forming a test chart by recording a test chart image onto the recording medium when a recording head is exchanged or the like, and detecting mispositioning of the recording head or of ink droplet ejection failure by reading the test chart inserted into a reflection manuscript insertion opening by an operator.

However, even if any abnormality occurs during recording successively a large number of images, the above-described function cannot detect the abnormality. Thus, it is extremely difficult to avoid significant decreases in processing ability and in acquisition rate of proper output images. In particular, the existing image recording system for recording an image by using a silver halide color photosensitive material has accomplished high processing ability by having been improved for a long time. In order to obtain the same performance as that of the existing image recording system by using the ink jet recording method, new measures are needed to improve the processing ability and acquisition rate of proper images.

### SUMMARY OF THE INVENTION

The present invention developed in consideration of the above-described facts, and a main object of the present invention is to provide an image recording apparatus and an image recording method can accomplish high ability of image recording using an ink jet recording method and an improvement in an acquisition rate of proper images.

In order to accomplish the object, in accordance with a first aspect of the present invention, there is provided an image recording apparatus comprising: a recording section for recording, on the basis of inputted image information, an image on a recording medium by ejecting recording droplets from an ejection opening of a recording head and adhering the droplets onto the recording medium; a monitoring section for monitoring and determining whether or not a phenomenon which may hinder image recording has occurred; and an adopting section for carrying out a process to overcome the phenomenon, when it is determined that said phenomenon has occurred.

In accordance with a second aspect of the present invention, there is provided an image recording method for recording an image onto a recording medium comprising the steps of: monitoring and determining whether or not any phenomena which may hinder image recording have occurred; and carrying out a processing to solve a phenomenon, when it is determined that said phenomenon has occurred.

### BRIEF DESCRIPTION OF THE DRAWINGS

FIG. 1 is a block diagram showing a schematic structure of an image recording system relating to the present embodiment.

FIG. 2 is a schematic structural view of an ink jet printer.

FIG. 3 is a side view of a periphery of a recording head of the ink jet printer.

FIG. 4 is a view typically showing a mechanism for supplying an ink to the recording head.

### DESCRIPTION OF THE PREFERRED EMBODIMENTS

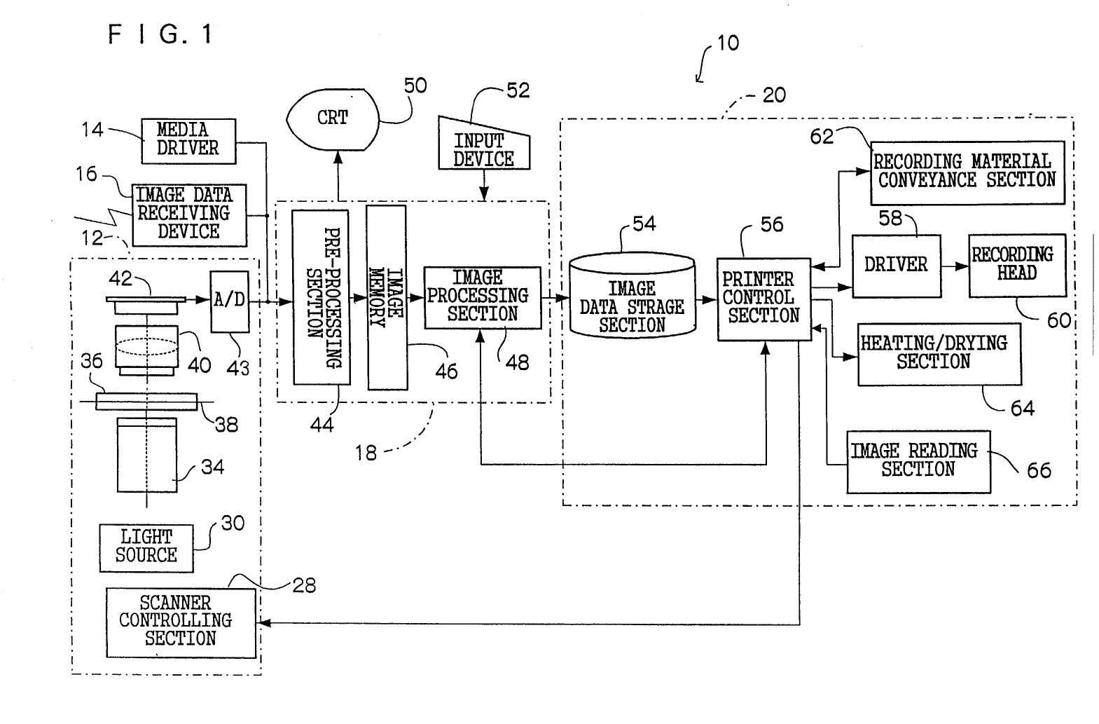

An example of the present embodiment will be described in detail with reference to the drawings. FIG. 1 shows a schematic structure of an image recording system 10 serving as an image recording apparatus relating to the present invention.

The image recording system 10 includes a film scanner 12, a media driver 14 and an image data receiving device 16, as an input device (an acquiring section) for inputting image data. Further, the image recording system 10 is provided with an image processing section 18 for processing image data inputted from the input device and an ink jet printer 20 for recording an image in an ink jet recording system, as an output device for outputting the image data (or an image) which was subjected to processes carried out by the image processing device 18.

Any of various kinds of storage mediums including magnetic disk such as floppy disks (FD), a optical disks such as a CD-R's, optomagnetic disks (MO's), and storage mediums which can be loaded into digital cameras (DSC's) such as PC cards, Smartmedia and IC cards (hereinafter referred to as digital camera cards), are set in the media driver 14. The image data which is stored on the information storage medium is read and outputted by the media driver 14. The image data receiving device 16 is connected to a computer network such as an internet, and receives R, G, B image data from an information processing device (for example, a personal computer (PC)) via the computer network and outputs the received image data.

The film scanner 12 reads a film image (a negative or positive image which becomes visible by being subjected to development processing after a subject is photographed: one type of original image recited in claims) recorded on a photographic photosensitive material such as a photographic film 38 (for example, a negative film or a reversible film). Then, the film scanner 12 outputs the image data obtained by reading the film image. Light is emitted from an LED light source 30 and unevenness of its amount is eliminated by a light diffusion box 34. Then, the light is irradiated onto the photographic film 38 set in a film carrier 36. The light which has transmitted the photographic film 38 is irradiated on a light receiving surface of an area CCD sensor 42 (or a linear CCD sensor) via a lens 40.

The film carrier 36 conveys the photographic film 38 intermittently such that film images are positioned one by one on an optical axis of light emitted from the LED light source 30 (i.e., positioned on a reading position). The LED light source 30 is formed by arranging a large number of LEDs for emitting R, G, B lights respectively on an entire surface of an unillustrated substrate with a fixed and high density. The LED light source 30 is driven by a driver (not shown) so as to emit R, G, B lights in that order when film recorded with a single image is positioned on the reading position.

Accordingly, film images recorded in the photographic film 38 are read one by one by the CCD sensor 42, and R, G, B and IR signals corresponding to the film images are outputted from the CCD sensor 42. The signals outputted from the CCD sensor 42 are converted into digital image data by an A/D converter 43 and the converted digital image data is inputted to the image processing device 18. The film scanner 12 is provided with a scanner controlling section 28. The film scanner controlling section 28 controls each action of the film scanner 12. Reading may be carried out for multiple times with respect to each film image (for example, a pre-scanning in which a film image is read with relatively low resolution and a fine-scanning in which a film image is read with relatively high resolution may be carried out).

A reflection type scanner which reads a reflection original (for example, a color paper with an image recorded thereon) and outputs image data obtained by reading the reflection original may be provided separately from the above-described film scanner 12, as an input device relating to the present embodiment. A reflection type scanner having an automatic feed mechanism which feeds automatically and continuously plural reflection originals to a reading section of a scanner is preferably used so as to enable automatic and continuous reading of plural reflection originals.

The above-described film scanner 12, the media driver 14 and the image data receiving device 16 are connected to a pre-processing section 44 of the image processing device 18. Image data outputted from such image data input devices is inputted to the pre-processing section 44. The pre-processing section 44 carries out different determined pre-processes for the inputted image data depending on a section to which the image data is inputted. Examples of pre-processes for the image data inputted from the film scanner 12 include dark-correction, density conversion, shading correction and correction of defective pixels. Examples of pre-processes for the image data inputted from the media driver 14 include decompression of compressed image data recorded in an information storage medium and image processing for improvement of sharpness. Examples of a pre-processing for the image data inputted from the image data receiving device 16 include decompression of compressed image data (for example, JPEG image data) received by the image data receiving device 16.

The pre-processing section 44 is connected to an image processing section 48 via an image memory 46. Image data subjected to pre-processing in the pre-processing section 44 is stored temporarily in the image memory 46. Then, the image data is read out by the image processing section 48 and inputted thereto. The image processing section 48 automatically computes processing conditions of various image processings for the image data on the basis of the image data read out of the image memory (computation set up).

Image processes for improving a quality of an output image are carried out in the image processing section 48, such as gray balance adjustment, density adjustment, gradation control, hypertone processing for compressing a gradation of an extremely low frequency luminance component of an image, hyper sharpness processing for emphasizing sharpness with granularity being suppressed, and defective portion correction processing for correcting, on the basis of IR data, defective portions of image data due to scratches on a photographic film or foreign matters adhered thereto. Alternatively, an image processing for changing an image tone intentionally (for example, an image processing in which an output image is processed like a portrait) or an image processing for processing an image (for example, an image processing in which a person in an original image is processed so as to look thinner on an output image) may also be carried out.

The image processing section 48 carries out various image processings for the image data read out from the image memory 46 in accordance with processing conditions determined by the set up computation. The image processing section 48 is connected to an image data storage section 54 of the ink jet printer 20. The image data subjected to various image processings is transferred to the image data storage section 54 and stored temporarily therein as image data for recording.

The image processing device 18 is configured to include a PC having a structure in which a CPU, a ROM, a RAM and an input/output port are connected together via buses and a storage device such as a hard disk device (HDD) or the like is connected to the input/output port. A CRT 50 and an input device 52 which is formed by a keyboard and a mouse are connected to the input/output port of the PC. The above-described pre-processing section 44 and the image processing section 48 can be enabled by enabling a PC to perform a predetermined program. Alternatively, the image processing device 18 may be configured to include dedicated hardware for carrying out various image processes.

Image processes are carried out for the image data on the basis of the processing conditions of the image processing obtained by the set up computation and the image data subjected image processing is outputted to the CRT 50. Thus, a simulation image which assumes a finish of an output image can be displayed on the CRT 50. Then, an operator checks the processing conditions obtained by the set up computation. If an operator instructs to correct the processing conditions by using the input device 52, the processing conditions can be corrected in accordance with the instruction.

A printer control section 56 which is formed by a microcomputer or the equivalent is connected to the image data storage section 54 of the ink jet printer 20. The printer control section 56 is connected to the scanner control section 28 of the film scanner 12 and the image processing section 48 of the image processing device 18. Connected to the printer control section 56 are a recording head 60 (to be described later in detail) via a driver 58, a recording material conveyance section 62, a heating/drying section 64 and an image reading section 66.

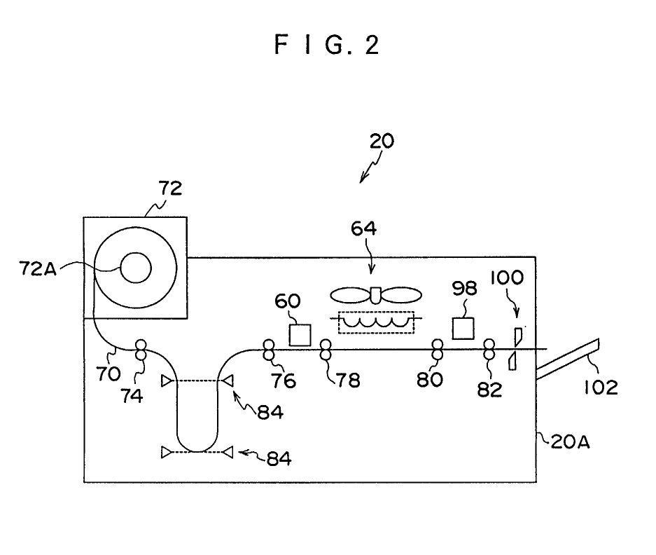

As shown in FIG. 2, the ink jet printer 20 has a housing 20A formed in a substantially box shape. A magazine 72 which accommodates an elongated recording material 70 which is wrapped around a reel 72A is disposed at one end portion of the housing 20A. While the magazine 72 is set at the housing 20A, the reel 72A is connected via a deceleration mechanism (not shown) to a motor for pulling out/conveyance (not shown), and rotated by a drive of the motor for pulling out/conveyance. Accordingly, the recording material 70 is pulled out from the magazine 70.

The recording material 70 pulled out from the magazine 72 is conveyed toward the other end of the housing 20A by pairs of conveyance roller 74, 76, 78, 80 and 82 disposed in a pull-out direction to the downstream side of the recording material 70. The conveyance roller pair 74 is rotationally driven by a driving force of the motor for pulling out/conveyance. The conveyance roller pairs 76, 78, 80 and 82 are rotationally driven due to driving force of a motor for simultaneous conveyance (not shown).

A loop forming mechanism (not shown) is disposed between the conveyance roller pairs 74 and 76. A loop of recording material 70 is formed between the conveyance roller pairs 74 and 76 by the loop forming mechanism. Two loop sensors 84 each of which is formed by a light emitting element and a light receiving element opposing each other in positions such that the loop is formed therebetween are disposed at two different height positions.

The recording material conveyance section 62 is formed by the motor for pulling out/conveyance, the motor for synchronized conveyance, the loop forming mechanism and the conveyance roller pairs 74, 76, 78, 80 and 82. Once a loop of the recording material 70 is formed by the loop forming mechanism at the printer control section 56, then, once the loop sensor 84 at an upper position does not detect the loop of the recording material 70 (i.e., a state in which light emitted from the light emitting element is received by the light receiving element without being blocked by the recording material), the motor for pulling out/conveyance is driven so as to rotate the reel 72A and the conveyance roller pair 74. Thus, the recording material 70 is pulled out from the magazine 72. When the loop sensor 84 at a lower position detects the loop of the recording material 70 (i.e., when light emitted from the light emitting element is not received by the light receiving element because the light is blocked by the lowermost portion of the loop of the recording material 70), the driving force of the motor for pulling out/conveyance is stopped, and the pulling out of the recording material 70 from the magazine 72 is stopped. This series of operations is repeated.

By forming the above-described loop, the conveyance of recording material 70 to the downstream side of the loop does not have to be synchronized with the recording material 70 being pulled out from the magazine 72. Thus, the printer control section 60 drives the motor for synchronized conveyance to rotationally drive the conveyance roller pairs 76, 78, 80 and 82 such that at the downstream side of the loop, the conveyance of the recording material 70 is synchronized with the recording of the image on the recording material 70 by the recording head 60.

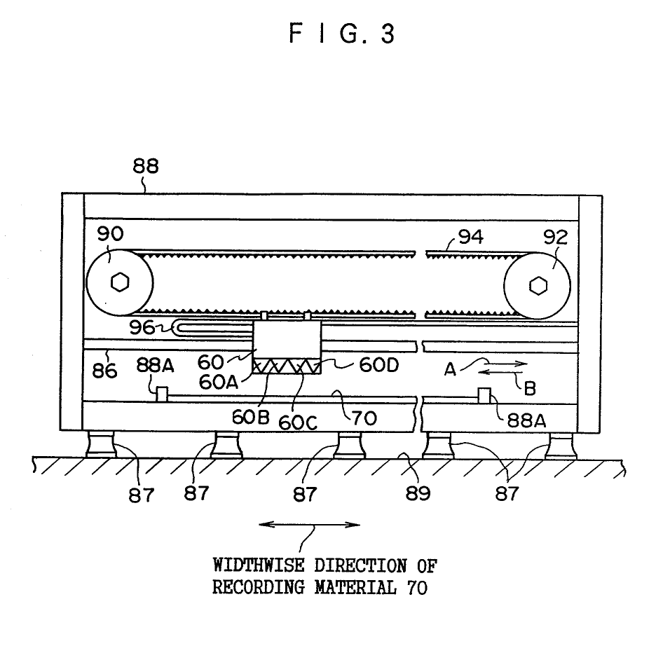

The recording head 60 is disposed above and between the conveyance roller pairs 76 and 68. As shown in FIG. 3, the recording head 60 is disposed in a vicinity of a conveyance path of the recording material 70. A shaft 86 passes through the recording head 60 along a widthwise direction of the recording material 70 and ends of the shaft 86 are supported by a box-shaped frame 88. The recording head 60 can move along a longitudinal direction of the shaft 86, i.e., along the widthwise direction of the recording material 70.

A path for the recording material 70 is formed at a bottom portion of the frame 88. Protrusions 88A for guiding widthwise direction ends of the recording material 70 passing through the frame 88 are formed. The protrusions 88A and the bottom surface of the frame 88 structure a support member for the recording material 70. The lower surface of the recording material 70, the recording material 70 which is conveyed by the conveyance roller pairs 76, 78, 80 and 82, is supported by the bottom surface of the frame 88 and the edges of the recording material 70 in the widthwise direction ends thereof are held at constant positions by the protrusions 88A. In such a state, an image is formed by the recording head 60 (details thereof will be described later).

The recording head 60 is mounted to an endless belt 94 which is wrapped about a pair of pulleys 90 and 92. The pair of pulleys 90 and 92 is axially supported by unillustrated brackets, and the brackets are mounted to the frame 88. The endless belt 94 is rotated in a clockwise direction and in a counter-clockwise direction as shown in FIG. 3 by a driving force of a scanning motor (not shown) being transmitted thereto. Accordingly, the recording head 60 is moved along the shaft 86 in a direction of the arrow A and in a direction of the arrow B shown in FIG. 3. Drive of the scanning motor is controlled by the printer control section 56.

A flexible harness 96 is mounted to the recording head 60. One end of the flexible harness 96 is fixed to a side plate of the frame 88 and pre-bent into a U-shape. The bent portion of the flexible harness 96 moves in accordance with movements of the recording head 60 in the directions of the arrows A and B shown in FIG. 3. The flexible harness 96 comprises signal lines for transmitting ejection signals generated at the driver 58, and hollow supply pipes for supplying inks to the recording head 60.

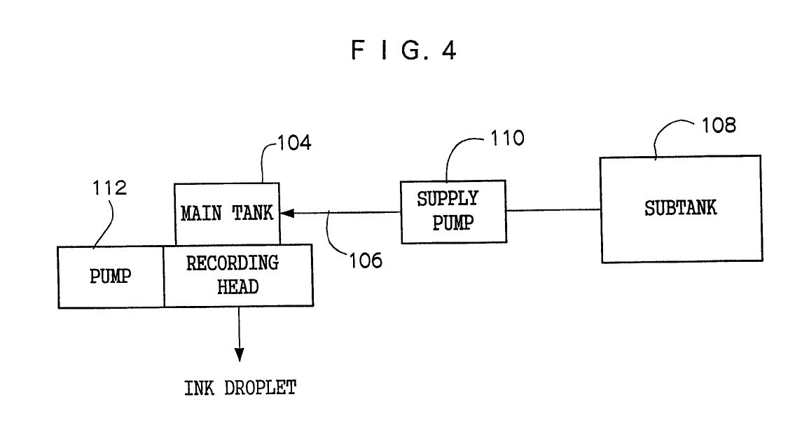

The recording head 60 is provided with, along the widthwise direction of the recording material 70, a plurality of nozzle rows (FIG. 3 shows four rows, i.e., 60A, 60B, 60C and 60D) each of which is formed by arranging a large number of nozzles in the longitudinal direction of the recording material 70. A plurality of ink chambers are formed within the recording head 60 in accordance with the respective nozzle rows. A plurality of main tanks 104 (see FIG. 4) each of which communicates with one of the ink chambers are mounted to the recording head 60.

Different color inks (e.g., C, M, Y, BK) are stored in the plural main tanks and are supplied to the respective nozzle rows via the ink chambers. Thus, color inks which are different from each nozzle row are ejected from the nozzles.

Specifically, a plurality of supply pipes 106 (see FIG. 4) which are a part of the above-described flexible harness 96 are provided to correspond to each color. One end of each of the supply pipes is connected to each of the plural main tanks 104. The other end of each of the supply pipes 106 is connected to one of the plural subtanks 108 (see FIG. 4) provided for each color, in the same way as the main tank 104. At an intermediate portion of the supply pipe 106, a supply pump 110 is provided for supplying ink from the subtank 108 to the main tank 104.

Since the main tank 104 mounted to the recording head 60 is moved together with the recording head 60, an ink storage capacity thereof is restricted by limitations of weight or size of the main tank 104. However, since the subtank 108 is formed separately from the recording head 60 in the present embodiment, there are fewer limitations in the size or weight of the subtank 108. Accordingly, in the present embodiment, the storage capacity of the subtank 108 is larger than that of the main tank 104. Thus, the work of resupplying ink to the subtank 108 does not have to be performed, and ink can be outputted on at least 30,000 cm² or more of images having 30% printing area.

Any method for ejecting inks from nozzles can be selected from among various known ejection methods. For example, as a representative method, a piezoelectric element method in which pulse voltage is applied to a piezoelectric element provided at an ink chamber so as to deform the piezoelectric element such that an ink droplet pressure within the ink chamber varies, and an ink droplets are ejected, or a thermal method in which ink is heated by a heating element provided within the ink chamber and an ink droplet is ejected from a nozzle by bubbles being generated within the ink chamber can be used. As shown in FIG. 4, in order to eliminate clogging of ejection openings of nozzles, the recording head 60 is provided with a pump 112 which absorbs inks within all of the ink chambers in the recording head 60 by a negative pressure being generated.

The printer control section 56 generates an image signal which represents timings for driving nozzles (e.g., timings for applying electricity to piezoelectric elements or to heaters provided in correspondence with the nozzles) on the basis of the image data for recording read out from the image data storage section 54 such that an image represented by the image data for recording is recorded on the recording material 70 on a dot-by-dot basis for each of the color components (e.g., C, M, Y and BK), the generated image signal is outputted to the driver 58 and the scanning motor is driven such that the recording head 60 moves along the shaft 86 at a predetermined movement speed.

The driver 58 generates, on the basis of the image signal inputted from the printer control section 56, an ejection signal for selectively driving nozzles at timings corresponding to the image signal (i.e., a signal for selectively applying electricity to the piezoelectric elements or the heaters of the nozzles). Then, the generated ejection signal is supplied to the recording head 60 via the flexible harness 96. Ink droplets ejected from the nozzles of the recording head 60 at timings corresponding to the image signal are adhered to the recording material 70. Meanwhile, a main scanning is performed by the recording head 60 being moved and a sub-scanning is performed by the recording material 70 being conveyed. In this way, a color image which is formed by rows of the same number of dots as nozzles which form nozzle rows provided at the recording head 60 is recorded on the recording material 70.

In the present embodiment, as described above, the mechanism for supporting and moving the recording head 60 (i.e., the shaft 86, the pulleys 90 and 92 around which the endless belt 92 is wrapped, and the like) and the support member for the recording material 70 are integrated with the frame 88 to form a recording unit comprising the recording head 60. A main body frame 89 of the ink jet printer 20 is positioned below the frame 88. A plurality of vibration dampening rubber pieces 87 serving as a vibration dampening device are disposed between the frame 88 and the main body frame 89 with a substantially constant interval therebetween. Various elastic bodies such as a natural rubber, a resin rubber, an elastomer and the like may be applied as the vibration dampening rubber pieces 87.

Thus, the recording unit formed by the recording head 60, the mechanism for supporting and moving the recording head 60, the support member for the recording material 70 and the frame 88 is vibrationaly isolated from the main body frame 89. Vibrations generated inside or outside the ink jet printer 20 and transmitted towards the main frame 89 can be prevented from being transmitted to the recording unit. Accordingly, regardless of the presence or absence of vibrations generated inside or outside the ink jet printer 20, positional relationships between components for forming the recording unit or between the recording head 60 and the recording material 70 can be maintained constant. As a result, variation of image quality of the recorded image can be suppressed.

Any vibration isolating device may be used as long as it can avoid, block or reduce propagation of vibrations from the main body frame 89 by absorbing an impact or vibration energy with elastic deformation in a direction of compression or of shearing. In addition to the above-described vibration dampening rubber pieces 87, for example, elastic bodies which do not have self-induced vibrations and have a high energy absorption effect due to a spring effect, such as a vibration isolating cork, a vibration isolating air spring, a vibration isolating metallic spring and the like, or a dynamic damper utilizing such elastic bodies can be used. A viscoelastic body is particularly preferably used as the vibration isolating device. As the viscoelastic body has an elastic force changed in accordance with a deformation speed, it can more reliably prevent propagation of the vibrations. As the vibration isolating device, the above-mentioned vibration isolating materials may be used alone or in combinations thereof. For example, the vibration dampening rubber pieces 87 is combined with a spring (a coil spring) to form the vibration isolating device.

Positions of the vibration dampening rubber piecess 87 between the frame 88 and the main body frame 89 are not restricted to the positions shown in FIG. 3. Positions of the vibration dampening rubber piecess 87 and the number of the vibration dampening rubber piecess 87 can be appropriately selected, as necessary. Above, the recording head 60, the mechanism for moving the recording head 60, the support member for the recording material 70 and the frame 88 have been integrated to form the recording unit. However, the present invention is not limited to such recording unit. The recording unit may be formed to comprise other mechanisms. For example, the entire mechanism for conveying the recording material 70 disposed between the position of the loop forming mechanism and the position of the heating/drying section 64 may be comprised to form the recording unit. If a back printing section or the equivalent which performs printing upon a back surface of the recording material 70 is disposed between the loop forming mechanism and the heating/drying section 64, the back printing section may be integrated with the recording unit.

A heating/drying section 64 is disposed between the conveyance roller pairs 78 and 80. The heating/drying section 64 blows heated wind for the recording material 70 with an image recorded thereon by ink droplets ejected from the recording head 60 being adhered thereto to heat and dry the ink. Purposes for heating the recording material 70 are as follows.

When an image is formed on a recording medium by ink droplets ejected from an ink jet recording head, it is preferable to perform a post-processing for providing a transparent polymer film on an outermost layer in order to improve water resistance or durability of the image and to maintain high image quality over a long period of time. The transparent polymer film has effects which improve the water resistance or weather resistance of the image. Here, transparency refers to as a state in which an image formed on a recording medium can be observed through a polymer film. Materials for the transparent polymer film are not particularly restricted, and various polymer materials may be used. That is, a water soluble polymer such as gelatin, polyvinyl alcohol or the like or a hydrophobic polymer such as polymethyl methacrylate or the like may be used.

There are various methods for forming the transparent polymer film as: (1) a method for forming a transparent polymer film by adhering a transparent polymer film prepared in advance; (2) a method for forming a transparent polymer film by applying a polymer solution; (3) a method for forming a transparent polymer film such that a liquid coating agent is applied to a surface of a recording medium subjected to image formation, solidified with ultraviolet or infrared ray to form a transparent overcoat layer; (4) a method for forming a transparent polymer film such that a thermoplastic resin porous layer is formed on the uppermost layer in advance, after image formation, the resin porous layer is heated (and pressed, if necessary) and made compact to form a transparent resin film; and (5) a method for forming a transparent polymer film such that a latex polymer is applied (may be applied to an entire surface by an ink jet method), heat-melted to form a transparent resin film. In the present embodiment, method (4) is used in view of simplicity and heating is performed in the heating/drying section 64, but other methods may be utilized.

The resin porous layer is preferably formed by thermoplastic resin particles being applied on silica or alumina hydrate porous layer and dried. Thermoplastic resins made of various thermoplastic materials may be used. Examples of the thermoplastic resin particles include thermoplastic resin particles included in latexes such as vinyl chloride, vinylidene chloride, styrene, acrylic, urethane, polyester, ethylene, amide, epoxy, vinyl chloride-vinyl acetate, vinyl chloride-vinyl acetate-acrylic, SBR, NBR and copolymers thereof . These particles may be used alone or in combinations of two or more kinds as long as they do not lose an ability to form a film. The thermoplastic resin particles have a diameter of 0.1 μm to 40 μm and preferably 2 μm to 20 μm.

To prepare a coating solution containing thermoplastic resin particles, such materials are dispersed in an appropriate solvent, e.g., a water soluble solution with solid amounts thereof ranging from 10 to 50% by weight. Such range can be appropriately adjusted in accordance with coating methods. In general, a coating solution is preferably coated to a dry layer thickness of 2 to 10 μm in order to impart surface gloss, suppress interference colors and function as a protective film.

After ink droplets are applied to the recording medium, the outermost layer serving as the porous thermoplastic resin layer is made to be non-porous (transparent), such that an image can be formed. If the porous thermoplastic resin layer is made into a nonporous layer, weather resistance of an image such as water resistance, light resistance or gas resistance can be superior, gloss is applied to the image, and the image can be stored for a long period of time.

As the method for making the outermost porous thermoplastic resin layer a non-porous layer, a method for heat-melting the porous thermoplastic resin layer is included. Although a heating temperature relates to time, a heating temperature in a range of 70° C. to 180° C. is preferable in view of effects for base materials, ink capacity or materials such as ink and surface property of the non-porous layer.

If necessary, a dispersing agent, a thickener, a pH adjusting agent, a lubricant, a fluidity modifier, a surfactant, a defoaming agent, a waterproofing agent, a releasing agent, an optical whitening agent, an ultraviolet absorber, or an antioxydant may be added into the outermost layer in such a range not as to hinder the present invention.

A three-line CCD sensor (or an area sensor) 98 which reads a color image (an output image) recorded on the recording material 70 is disposed between the conveyance roller pairs 80 and 82. The CCD sensor 98 forms part of the image reading section 66. An image signal outputted from the CCD sensor 98 is inputted to the printer control section 56 as output image data indicating an output image via an amplifier, an A/D converter and a correction section for performing corrections such as dark correction and the like, which are included in the image reading section 66 (none of them are shown).

A cutter 100 which cuts the elongated recording material 70 into the respective images is provided at the downstream side of the conveyance roller pair 82. The recording materials 70 cut into the respective images by the cutter 100 are discharged on a tray 102 provided at the outside of the housing 20A.

Next, a processing ability maintaining process performed by the printer control section 56 of the ink jet printer 20 will be described as an operation of the present invention. In the processing ability maintaining process performed by the printer control section 56, whether or not the following phenomena (1) through (5) occur is monitored while a large number of images are being successively recorded on the recording material 70. The phenomena are (1) clogging of ejection openings of the recording head 60, (2) a decrease in an ejection amount of ink droplets from the recording head 60, (3) output image failure due to other causes, (4) a decrease in a vacant capacity of the image data storage section 54 and (5) complete consumption of the recording material 70.

Whether or not the phenomena (1) through (3) occur is monitored by using the output image data inputted from the image reading section 66. Specifically, the printer control section 56 has the image reading section 66 read a portion of or all of the output images (preferably all images, alternatively, every other frame or every few frames) outputted by being recorded on the recording material 70 with the ink jet printer 20. Then, the printer control section 56 obtains the output image data.

The image data for recording inputted from the image processing device 18 to the ink jet printer 20 continues to be stored in the image data storage section 54 until it is determined that the image quality of the output image corresponding to the image data is appropriate. Thus, the printer control section 56 carries out image processings for one of the output image data and the image data for recording, such as resolution conversion performed such that a resolution of one image data coincides with a resolution of the other image data and density conversion performed such that a screen average density of one image data coincides with a screen average density of the other image data.

In order to avoid a decrease in judgement accuracy of a process to be described later due to small amounts of deviation of pixel positions and to reduce a processing time, the resolution of the output image data and of the image data for recording may be converted to the same, low resolution.

Next, the density of respective color components of the pixels of the output image data and the image data for recording which passed through the above image processing are compared and it is judged whether or not there are pixels the individual color densities of whose individual color components exceed a fixed value, the fixed value being set in consideration of error variance. If a difference of the density of pixels for each color component between the image data for recording and the output image data is less than a predetermined value, it is determined that the image quality of the output image is an appropriate image quality which substantially coincides with the image quality of the image indicated by the image data for recording. Accordingly, it is determined that the phenomena (1) through (3) did not occur. The processing for the output image ends, and the corresponding image data for recording is deleted from the image storage section 54.

On the other hand, if there are pixels having a density difference for each color component of at least the predetermined value or more compared with that of the image data for recording, the number of such pixels and conditions of distribution of such pixels on the image are judged. For example, if there are extremely few pixels having at least a predetermined value of density difference for each color component compared with that of the image data for recording, and such pixels are not concentrated in a specific portions on the image, it is determined that visible variation of image quality does not occur and the phenomena (1) through (3) do not occur. The processing for the corresponding output image ends, and the corresponding image data for recording is deleted from the image data storage section 54.

If only a part of output images is read, the image data for recording corresponding to images which were not read by the image reading section 66 is treated as follows. That is, if it is determined that the phenomena (1) through (3) did not occur, among a read image, then for images next to and previous to a read image in the order of recording of the images on the recording material, the image data for recording is deleted from the image data storage section 54.

If a predetermined number or more of pixels having at least the predetermined value of density difference for each color component from that of the image data for recording exist, it is determined that the phenomena (1) through (3) may have occurred. Deletion of the image data for recording from the image data storage section 54 is postponed. It is determined whether or not pixels having a predetermined value or more of the density difference for each color component from that of the image data for recording are successively positioned along a direction corresponding to the widthwise direction of the recording material 70.

In the recording head 60 relating to the present embodiment, if an ejection opening of a specific nozzle clogs such that a specific color ink is not ejected from the ejection opening, or an ejection amount of a specific color ink is reduced, a defective portion in which portions that are missing the specific color appear successively on the output image as a line along the widthwise direction of the recording material 70. Images are recorded by the recording head 60 in such a manner that the recording material 70 is conveyed in a longitudinal direction thereof, while the recording head 60 is reciprocated in the widthwise direction of the recording material 70. Thus, the above-described defective portion appears periodically along a direction corresponding to the longitudinal direction of the recording material 70.

If the ejection opening of the specific nozzle in the recording head 60 clogs, the same defective portion appears on a plurality of output images. Thus, if the above-described defective portion is detected, whether or not the defective portion exists is determined for the output images recorded at times which are close with one another. If the defective portion is detected in the output images, whether or not periods that the defective portion appears are same with one another is determined. In this way, accuracy of determination of clogging of the ejection opening can be further improved.

If the above-described conditions are satisfied, the printer control section 56 determines that an ejection opening of a specific nozzle in the recording head 60 has clogged. Then, image recording performed by the recording head 60 is stopped temporarily and a pump 112 is operated. Thus, clogging of the ejection opening is eliminated. If a large number of ejection openings of nozzles clog at the same time, deficiencies may appear in a part of output image or entire output image. Alternatively, there may be a case in which images are not recorded at all. As such a case also satisfies the above-described conditions, a process for eliminating clogging of ejection openings of the recording head 60 is carried out. Output images on which a defective portion is detected are thrown away as abnormal images. When it is determined that clogging of the ejection openings has been eliminated, images are re-recorded again by using image data for recording stored in the image data storage section 54.

As described above, in order to operate the pump 112, image recording must be temporarily interrupted. Thus, if the density variation due to clogging of an ejection opening is relatively little, and a nozzle with a clogged ejection opening can be identified, the density variation may be compensated for by adjusting only the ejection signal for driving the specified nozzle.

If a predetermined number or more of pixels having a predetermined value or more of the density difference for each color component from that of the image data for recording exits, and such pixels distribute substantially uniformly over the entire output image, that is, if a color tint of the image varies as a whole, the printer control section 56 determines that the phenomenon (2) occurs for a specific color, i.e., the printer control section 56 determines that an ejection amount of ink droplets from the recording head 60 has decreased. Then, image recording performed by the recording head 60 is stopped temporarily and the supply pump 110 is operated. Thus, a specific color ink is supplied from the subtank 108 to the main tank 104.

If a decrease in the ejection amount of ink droplets occurs because of a lack of ink supply to the recording head 60, as described above, a decrease in the ejection amount can be solved by operating the supply pump 110. Output images which satisfy the above-described conditions are thrown away as abnormal images. If it is determined that a lack of ink supply has been solved, images are recorded again by using the image data for recording stored in the image data storage section 54.

Color tint variation can also appear on a plurality of output images if a decrease in the ejection amount of ink droplets from the recording head 60 occurs (i.e., a predetermined number or more of pixels having a predetermined value or more of the density difference for a specific color component exist on entire output image substantially uniformly). Thus, when the above-described image quality deterioration is detected, whether or not the color tint variation occurs with respect to the plurality of output images recorded at times close one another is determined. Thus, an accuracy for determining a decrease in the ejection amount of ink droplets from the recording head 60 can be further improved.

Since a decrease in the ejection amount of ink droplets from the recording head 60 may occur for causes other than a lack of ink supply, a decrease in the ejection amount may not be improved even if the supply pump 110 is operated. In such cases, rather than operating the supply pump 110, changing only an output signal for a driving a nozzle which outputs a specific color to compensate for the small amount of ink droplets is acceptable.

If the ejection amount of ink droplets from the recording head 60 is extremely reduced, and such extreme decrease of the ejection amount does not improve even if the supply pump 110 has been operated, causes for such phenomenon are considered to include a failure of the supply pump 110 or complete consumption of the ink stored in the subtank 108. In such cases, even if an ejection signal is varied, it is difficult to improve a decrease in the ejection amount. Accordingly, an operator is called by operating an alarm. (For example, the image processing device 18 may be instructed to generate a predetermined sound or to display a message on the CRT (display) 50 to ask an operator to check an ink amount remaining in the subtank 108 or a failure of the supply pump 110.) In this way, it is possible to avoid the number of prints processed per unit time from being reduced because the ejection amount has been extremely decreased, i.e., images have not been able to be recorded normally.

If image quality deterioration such as the above-described defective portion or color tint variation is detected for a specific image, but the same deterioration does not occur in other output images, it is determined that detected image quality variation is temporary image quality deterioration occurred suddenly, such as changes of data at a time of transferring the image data for recording or temporary variation of electric supply voltage at a time of image recording. Thus, in such cases, the printer control section 56 determines that the phenomenon (3) occurs, i.e., output image failure occurs due to other causes. Only a specific output image that the image quality deterioration detected is re-recorded using the same image data for recording. Accordingly, in most cases, an output image with appropriate image quality can be obtained.

Whether or not the phenomenon (4), i.e., a decrease in vacant capacity of the image data storage section 54 occurs is monitored by always monitoring the vacant capacity of the image data storage section 54. Specifically, the printer control section 56 stores the vacant capacity of the image data storage section 54. When the image data for recording outputted from the image processing device 18 is accumulated and stored in the image data storage section 54, the stored vacant capacity decreases by an amount of image data stored. When it is determined that the image quality of the output image is appropriate, and the corresponding image data for recording is deleted from the image data storage section 54, the stored vacant capacity increases by an amount of the deleted image data for recording.

Every time when the stored vacant capacity is updated, it is determined whether or not an updated vacant capacity becomes a predetermined value or less. If the determination is negative, no processing is carried out. However, if, for example, as described above, an ejection opening of the recording head 60 clogs and thus image recording is stopped temporarily in order to operate the pump 112, then output images with defective portions must be recorded again, the vacant capacity of the image data storage section 54 is simply decreased until re-recording of images is completed. Accordingly, there is high possibility that the determination is affirmed. If the determination is affirmed, the image processing device 18 is instructed to stop temporarily outputting of the image data for recording.

In this way, it is possible to avoid such troubles that image recording cannot performed in the ink jet printer 20 or processings in the image processing device 18 stop during the processings. Such troubles are caused by the image data storage section 54 becoming full during accumulation and storing the image data for recording inputted from the image processing device 18 such that a communication sequence for transferring the image data for recording stops during its processing.

When images are recorded on the recording material 70 by using the image data outputted successively from the film scanner 12 by the film scanner 12 reading successively film images, instead of instructing the image processing device 18 to stop outputting of the image data for recording as described above, the film scanner 12 may be instructed to stop temporarily reading of the film images.

Whether or not the phenomenon (5) occurs, i.e., whether or not a total amount of the recording material 70 is consumed is determined by judging whether or not an amount of load applied to the pulling out/conveyance motor at a time of driving thereof is a predetermined value or less, or by judging whether or not a predetermined period of time elapses since the loop sensor 84 at the upper position does not detect the recording material 70, even if the pulling out/conveyance motor is driven. When it is determined that the total amount of the recording material 70 is used up, an operator is called by operating an alarm (For example, the image processing device 18 may be instructed to generate a predetermined sound or to display a message on the CRT 50 for asking an operator to exchange the magazine 72). Accordingly, it is possible to avoid a decrease in the number of prints processed because the magazine 72 has not been exchanged or images have not been recorded.

Next, a processing for maintaining throughput performed by the image processing section 48 of the image processing device 18 will be described briefly. In the throughput maintaining processing performed by the image processing section 48, whether or not the following phenomena (6) through (8) occur in parallel to image recording. Such phenomena includes (6) failures of input devices, (7) reading error of the photographic film 38 by the film scanner 12 and (8) a format error of the input image data. The phenomena (6) and (7) correspond to failures of acquiring sections recited in the claims, and the phenomenon (8) corresponds to obtaining inferior original image information by the acquiring sections recited in the claims.

Since the image processing device 18 receives image data from input devices, it has a function of communicating with the image data. If a communication error arises with a specific input device, the image processing section 48 determines that the phenomenon (6) has occurred in the specific input device, i.e., the specific input device has broken. If abnormality has occurred in the image data inputted from the image film scanner 12, e.g., a density of all pixels is extremely high or low, and the image processing section 48 determines that the phenomenon (7) has occurred at the film scanner 12, i.e., a reading error has occurred. If the image data inputted from the media driver 14 or the image data receiving device 16 has a different format from a predetermined format, the image processing section 48 determines that the phenomenon (8) has occurred in the media driver 14 or the image data receiving device 16, i.e., there a format error has arisen in the image data received by the media driver 14 or the image data receiving device 16.

If it is determined that any of the above-described phenomena (6) through (8) occurs, an operator is called by operating an alarm (e.g., by generating a predetermined sound or by displaying a message for notifying occurrence of errors on the CRT 50). Accordingly, it is possible to avoid a decrease in the number of prints processed per unit time because the above-described phenomenon occurs, i.e., images have not been recorded.

As the algorithm for monitoring occurrence of the phenomena (1) through (3), a description has been given of an example of comparing the output image data with the image data for recording and of comparing a plurality of output image data with one another. The algorithm is only an example, and either the comparison of the output image data with the image data for recording or the comparison of the plurality of output image data may be performed.

As the image data used for the comparison with the output image data, instead of the image data for recording (corresponding to “image information outputted from an image processing section” recited in the claims), image data (corresponding to original image information in the present invention) inputted from the input device (i.e., the film scanner 12, the media driver 14 or the image data receiving device 16) or image data obtained by carrying out a predetermined image processing (e.g., an easy image processing including conversion with an LUT (look-up table), matrix computation or the like) for the image data may be used. In particular, even if the above-described image data is used, partially or entirely missing portions on the output image due to clogging of the ejection opening of the nozzle in the recording head 60 can be detected with high precision.

If an original image is a film image recorded in the 135 size photographic film 38, it is possible to easily detect whether the recording format of the film image which is the original image is a 135 size standard format or a panorama size format by using the above-described image data. Thus, by comparing the output image data to the above-described image data, it is possible to detect that image processing failure (corresponding to “image processing failure in an image processing section” recited in the claims) has occurred at the image processing device 18, for example, although the recording format of the film image is a panorama size format, the recording format is misdetected as a 135 size standard format, and image processing for the 135 size standard format is performed.

In FIG. 2, a description has been given of the ink jet printer 20 as an example in which the recording material 70 cut on an image-by-image basis is discharged into a single tray 102 provided outside the housing 20A, but the present invention is not limited to such ink jet printer 20. An accommodation section formed of a tray or a box for accommodating recording materials cut on an image-by-image basis may be provided separately from the tray 102. Further, a first guide mechanism for selectively guiding the recording materials cut on an image-by-image basis to the tray 102 or the accommodating section may be provided. An operation of the first guide mechanism may be controlled such that output images judged as a normal image are discharged into the tray 102, and output images judged as an abnormal image are accommodated in the accommodating section. Thus, it is not necessary to select output images judged as an abnormal image from the output images discharged into the tray 102, and the output images can be thrown away easily. In this aspect, if it takes time to read an output image by the CCD sensor 98 and then determine whether the output image read is a normal image or an abnormal image, it may need a stock section for stocking an output image without discharging outside of the housing 20A until it is determined whether or not the output image is a normal image or an abnormal image. If whether the output image is a normal image or an abnormal image is determined by comparing the output image data with the image data for recording, it is preferable because such determination can be performed in a short time, the above-described stock section is omitted, and thus the ink jet printer 20 can be made compact.

Alternatively, a plurality of trays 102 may be provided, and a second guide mechanism for selectively guiding output images judged as a normal image to one of the plurality of trays 102 may also be provided. If the second guide mechanism is controlled such that output images judged as a normal image are discharged into the respective trays 102 for each case, it is preferable because it is not necessary to classify output images discharged on the tray 102 for each case.

A description has been given of an example in which the pump 112 for absorbing inks within all ink chambers in the recording head 60 by generating a negative pressure is provided as a cleaning device recited in the claims. Individual pumps may be provided for each ink chamber. Alternatively, all of the ink chambers may be grouped into a plurality of groups each of which comprises a plurality of ink chambers. Then, each pump may be provided for each ink chamber group. A switching mechanism for switching, with each ink chamber or each ink chamber group being an unit, an ink chamber or an ink chamber group which introduces a negative pressure generated by a single pump may be provided. Thus, an ink within an ink chamber may be absorbed selectively with each ink chamber or each ink chamber group being an unit. If it is detected that an ejection opening of a nozzle clogs, the nozzle whose ejection opening has clogged is specified, and then only ink within an ink chamber corresponding to the nozzle or within an ink chamber group including the ink chamber corresponding to the nozzle may be absorbed such that the clogging of the ejection opening of the nozzle is eliminated.

Further, as the above-described cleaning device, instead of the mechanism for absorbing an ink within an ink chamber, a mechanism for eliminating clogging of an ejection opening of a nozzle by “flushing” in which a nozzle is driven to eject an ink or by “wiping” in which unnecessary ink adhered to a nozzle surface is wiped off may be utilized. In a case of utilizing such mechanism, cleaning may be performed with a nozzle which is judged that clogging occurs, a nozzle group including the nozzle with the clogged ejection opening and a plurality of nozzles in a vicinity of the nozzle, or all nozzles as a unit.

As described above, in accordance with the present invention, it is possible to accomplish an improvement in an ability of image recording with an ink jet recording method and an improvement in an acquisition rate of appropriate images.

In accordance with the present invention, it is possible to detect occurrence of various phenomena which hinder image recording without providing dedicated sensors.

In accordance with the present invention, it is possible to detect the occurrence of the phenomena which hinder image recording with high precision.

In accordance with the present invention, it is possible to continue image recording without decreasing an image quality of output images.

What is claimed is

1. An image recording apparatus comprising:
a recording section for recording, on the basis of inputted image information, an image on a recording medium by ejecting recording droplets from an ejection opening of a recording head and adhering the droplets onto the recording medium;
a monitoring section for monitoring and determining whether or not a phenomenon which may hinder image recording has occurred; and
an adopting section for carrying out a process to overcome the phenomenon, when it is determined that said phenomenon has occurred.

2. The apparatus of claim 1 further comprising:
a storage section for storing the image information.

3. The apparatus of claim 2, wherein the monitoring section monitors whether at least one of failure of the recording section and a decrease in a vacant storage capacity of the storage section has occurred.

4. The apparatus of claim 1 further comprising:
an acquiring section for acquiring original image information which represents an original image to be recorded on a recording medium; and
an image processing section for generating the image information which represents an image to be recorded on the recording medium and for outputting said the image information to the recording section by image processing said original image information.

5. The apparatus of claim 1, wherein the monitoring section monitors whether at least one of failure of the acquiring section, inferior obtaining of original information by the acquiring section, and failure of image processing by the image processing section has occurred.

6. The apparatus of claim 1 further comprising:
a reading section for photoelectrically reading an output image recorded on the recording medium.

7. The apparatus of claim 6, wherein the monitoring section monitors, based on a result of the reading performed by the reading section, whether said phenomenon has occurred.

8. The apparatus of claim 7, wherein when it is determined that a phenomenon for inducing a decrease in an image quality of an output image has occurred, in order to eliminate a decrease in the image quality which hinders image recording, the adopting section adjusts, on the basis of results of the reading performed by the reading section, an ejection amount of recording droplets such that a decrease in the image quality of the output image is corrected.

9. The apparatus of claim 6, wherein the monitoring section monitors whether said phenomenon has occurred by one of comparing results of the reading of a plurality of output images performed by the reading section with one another and by comparing the results of the reading performed by the reading section to the image information corresponding to said output image.

10. The apparatus of claim 9 further comprising:
an acquiring section for obtaining original image information which indicates an original image to be recorded on a recording medium; and
an image processing section for generating the image information which indicates an image to be recorded on the recording medium by carrying out an image processing for said original image information and for outputting the image information to the recording section.

11. The apparatus of claim 10, wherein the monitoring section uses, as the image information corresponding to said output image, at least one of original image information, image information obtained by carrying out a predetermined image processing of the original image information and image information outputted from the image processing section.

12. The apparatus of claim 1 further comprising:
a cleaning section for cleaning around an ejection opening of the recording head.

13. The apparatus of claim 12, wherein the adopting section operates the cleaning section when it is determined that an ejection opening of the recording head has clogged.

14. The apparatus of claim 1, wherein when it is determined that a decrease in an ejection amount of recording droplets from an ejection opening of the recording head has occurred, the adopting section adjusts to do one of increase an ejection amount and supply a recording solution to the recording head.

15. The apparatus of claim 1 further comprising:
a main tank which is provided in the recording head and stores a recording solution;
a supply mechanism for supplying the recording solution to the main tank; and
a subtank connected to the main tank via the supply mechanism.

16. The apparatus of claim 15, wherein the adopting section controls the supply mechanism to supply a recording solution from the subtank to the main tank.

17. The apparatus of claim 2 further comprising:
an input section for inputting information relating to an image into the recording section.

18. The apparatus of claim 17, wherein when it is determined that a decrease in a vacant storage capacity of the storage section has occurred, the adopting section controls the input section to temporarily stop input of the image information.

19. The apparatus of claim 1, wherein when it is determined that said phenomenon has occurred, said adopting section operates an alarm to call an operator.

20. An image recording method for recording an image onto a recording medium comprising the steps of:
monitoring and determining whether or not any phenomena which may hinder image recording have occurred; and
carrying out a processing to solve a phenomenon, when it is determined that said phenomenon has occurred.
